(19) United States
(12) Patent Application Publication
(10) Pub. No.: US 2025/0392542 A1
(43) Pub. Date: Dec. 25, 2025

(54) OPTIMAL WAY TO SUPPORT DEVICE SWITCHOVERS IN CLOUD ENVIRONMENTS

(71) Applicant: Palo Alto Networks, Inc., Santa Clara, CA (US)

(72) Inventors: Yu Zhang, Pleasanton, CA (US); Badrinath Natarajan, San Jose, CA (US); Pankaj Bhagra, Fremont, CA (US)

(21) Appl. No.: 18/752,385

(22) Filed: Jun. 24, 2024

(51) Int. Cl. H04L 45/00; H04L 41/0663; H04L 45/741

(52) U.S. Cl. CPC H04L 45/38; H04L 41/0663; H04L 45/741

(57) ABSTRACT

The present application discloses a method, system, and computer system for performing failovers of traffic carrying devices. The method includes (i) generating, by one or more processors a virtual routing IP address that is common to a plurality of network nodes, and (ii) sending to an upstream device a physical IP address for a particular network node of the plurality of network nodes, wherein the physical IP address is sent as metadata in a packet to the upstream device.

### BACKGROUND OF THE INVENTION

In the rapidly evolving landscape of cloud computing, the continuous availability and reliability of services are paramount for businesses and organizations. As enterprises increasingly migrate critical applications and data to the cloud, ensuring minimal downtime and uninterrupted access becomes a critical requirement. This necessity has driven the development of robust solutions for device switchovers and failovers in cloud-based environments.

In traditional IT infrastructures, hardware redundancy and manual intervention were primary methods to handle device failures. However, these approaches are neither scalable nor efficient in the context of cloud computing, where services are distributed across multiple virtualized environments. The dynamic and distributed nature of cloud infrastructure demands automated, seamless failover mechanisms to maintain high availability and reliability.

Upstream (or even downstream) network elements need to react to such switchovers and send data packets to the correct device following the switchover. As cloud adoption continues to grow, the importance of systems that support device switchovers or failovers will only increase.

### BRIEF DESCRIPTION OF THE DRA WINGS

Various embodiments of the invention are disclosed in the following detailed description and the accompanying drawings.

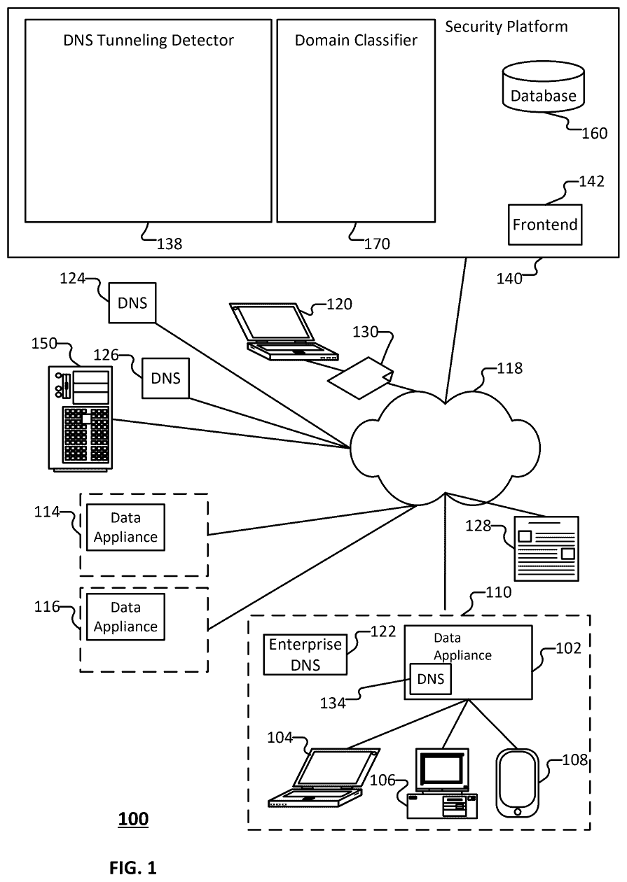

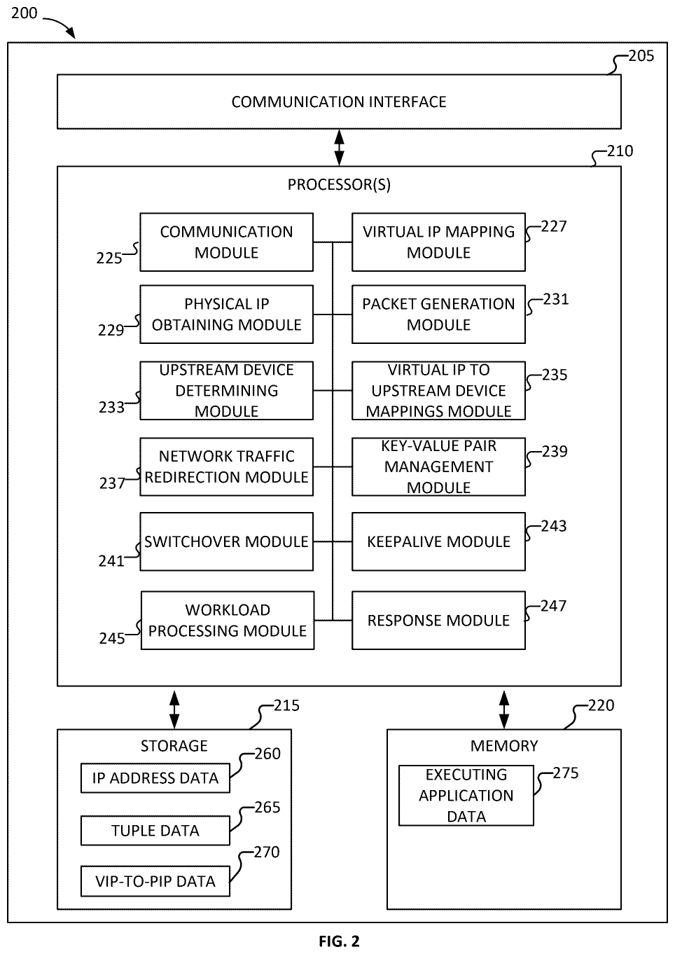

FIG. 1 is a block diagram of an environment for providing a security service according to various embodiments.

FIG. 2 is a block diagram of a system to detect perform a failover to another network node according to various embodiments.

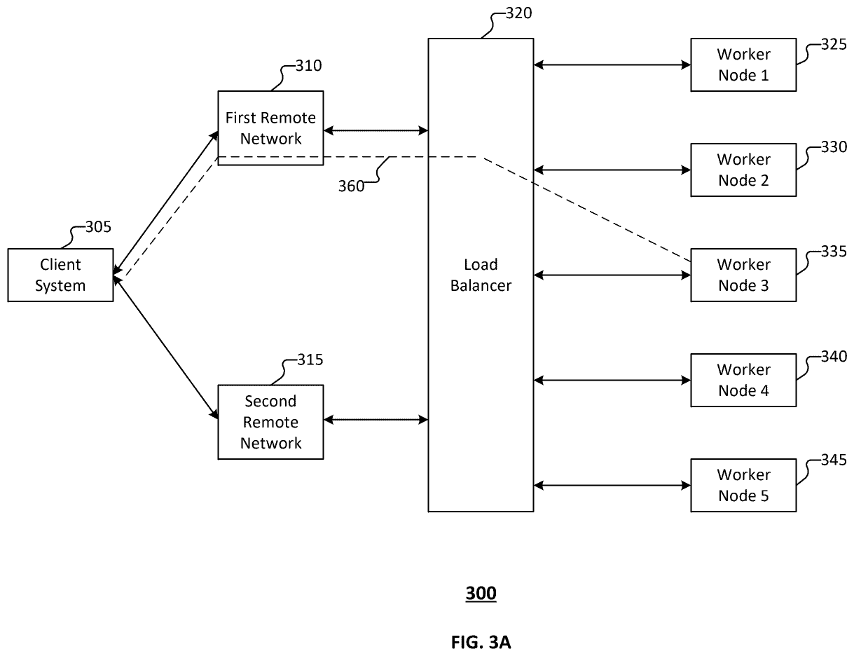

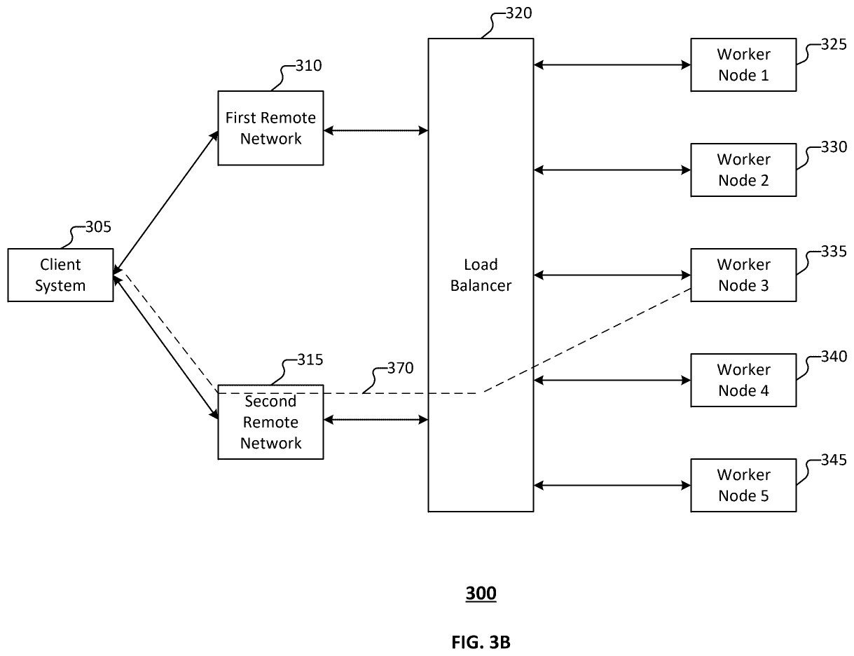

FIG. 3A is an illustration of a system for performing a failover to another network node according to various embodiments.

FIG. 3B is an illustration of a system for performing a failover to another network node according to various embodiments.

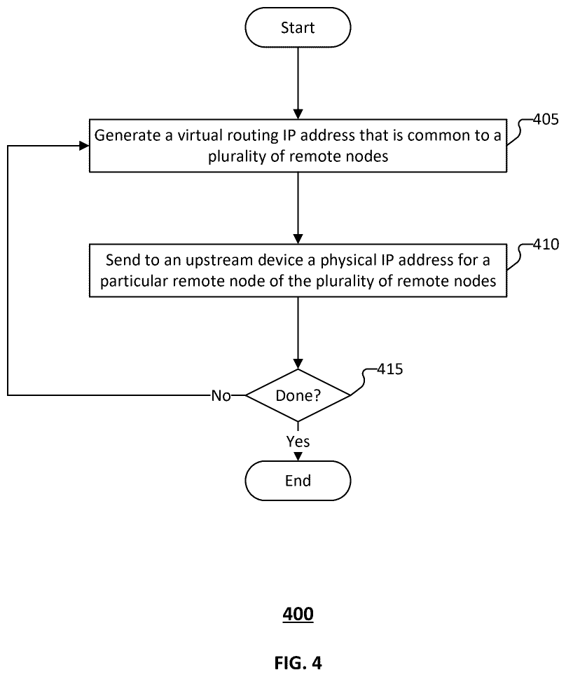

FIG. 4 is a flow diagram of a method for communicating network traffic in a manner that ensures that traffic is properly routed in the event of a switchover or failover according to various embodiments.

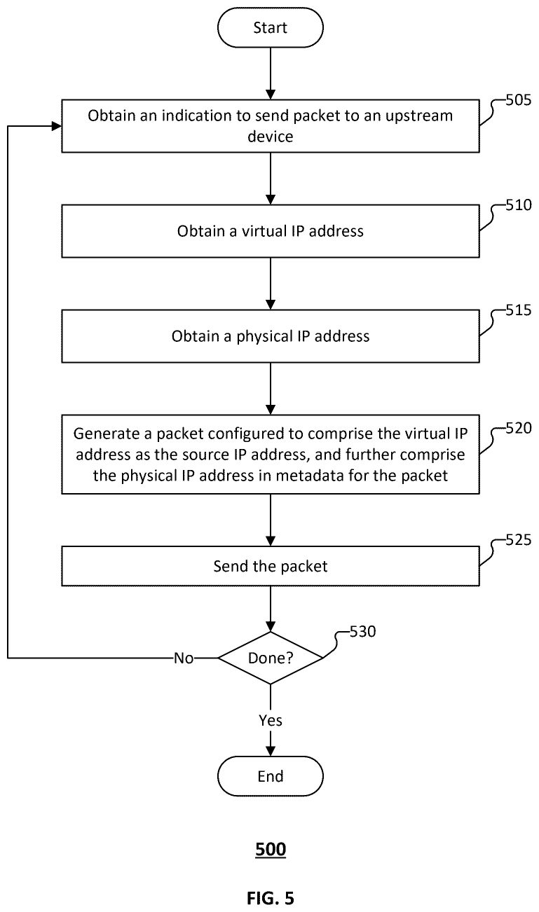

FIG. 5 is a flow diagram of a method for communicating network traffic in a manner that ensures that traffic is properly routed in the event of a switchover or failover according to various embodiments.

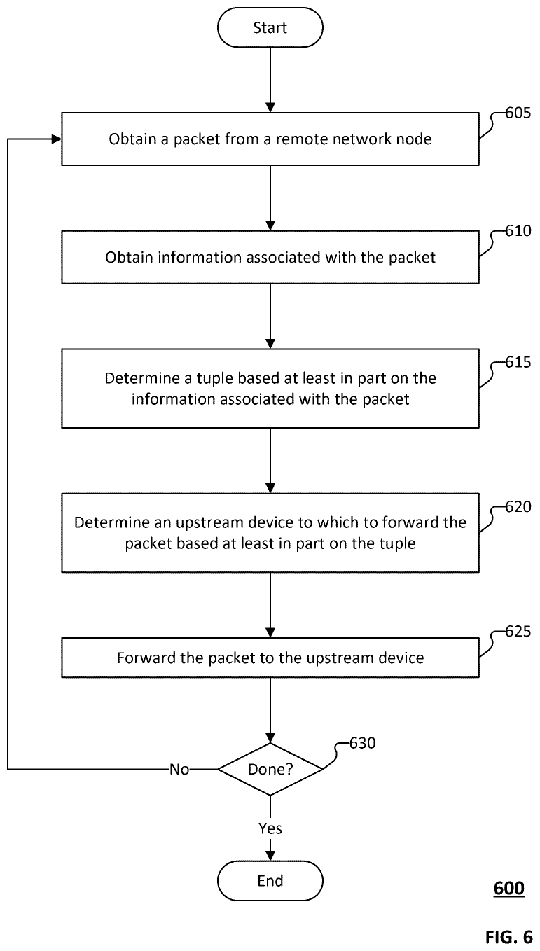

FIG. 6 is a flow diagram of a method for routing network traffic in a manner that ensures that traffic is properly routed in the event of a switchover or failover according to various embodiments.

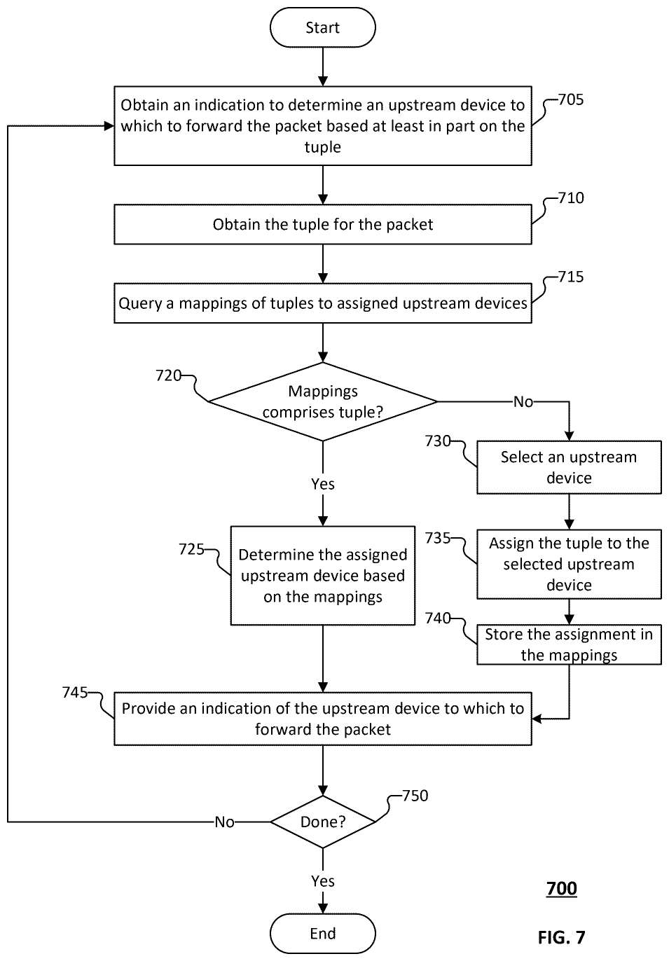

FIG. 7 is a flow diagram of a method for determining an upstream device to which to route or forward network traffic according to various embodiments.

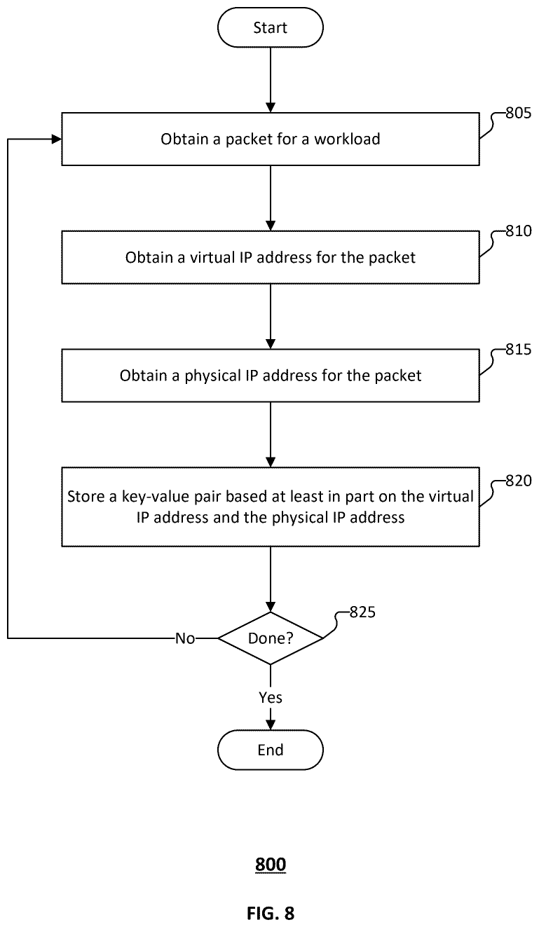

FIG. 8 is a flow diagram of a method for managing an indication of an active network node to which to provide response data according to various embodiments.

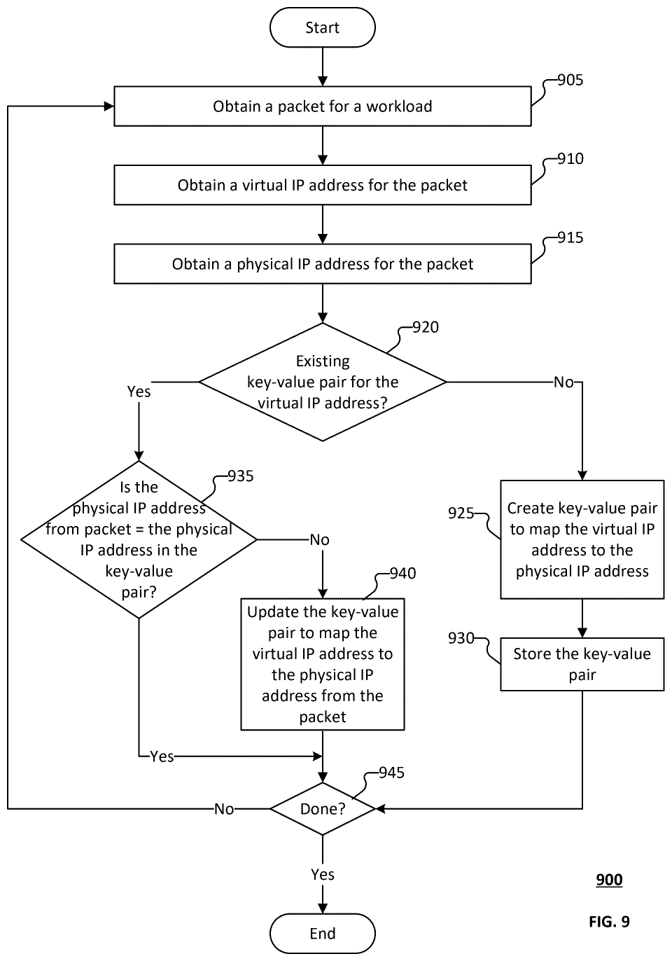

FIG. 9 is a flow diagram of a method for managing an indication of an active network node to which to provide response data according to various embodiments.

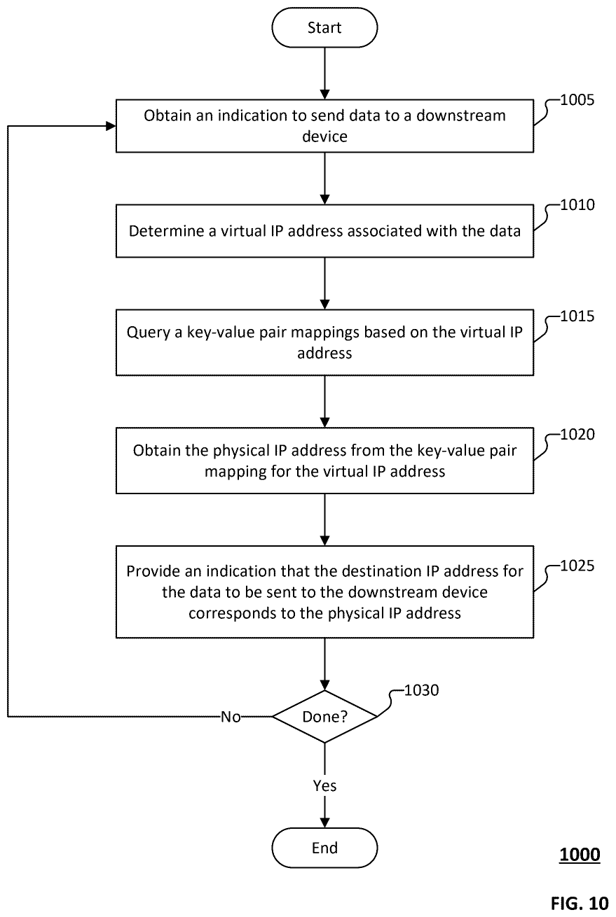

FIG. 10 is a flow diagram of a method for determining a downstream network node to which response data is to be provided according to various embodiments.

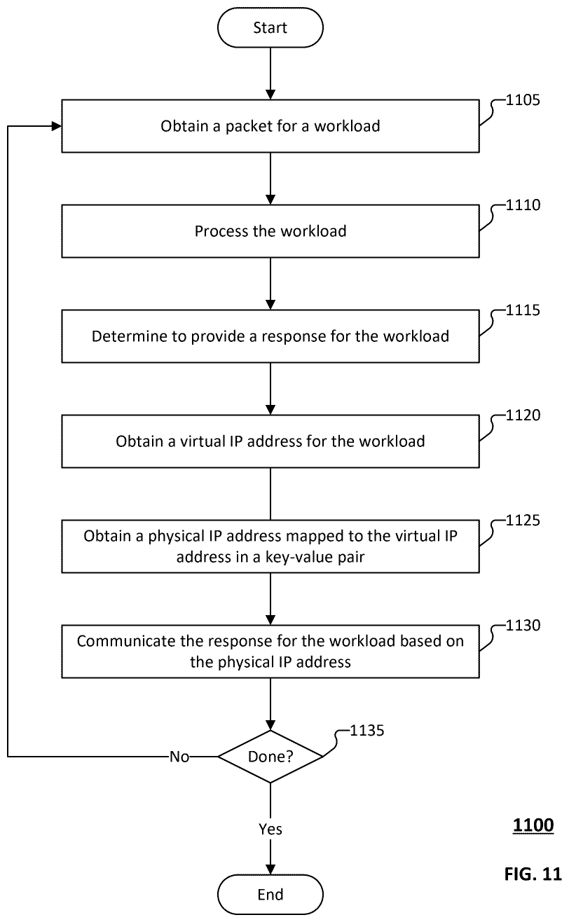

FIG. 11 is a flow diagram of a method for processing a workload and providing response data according to various embodiments.

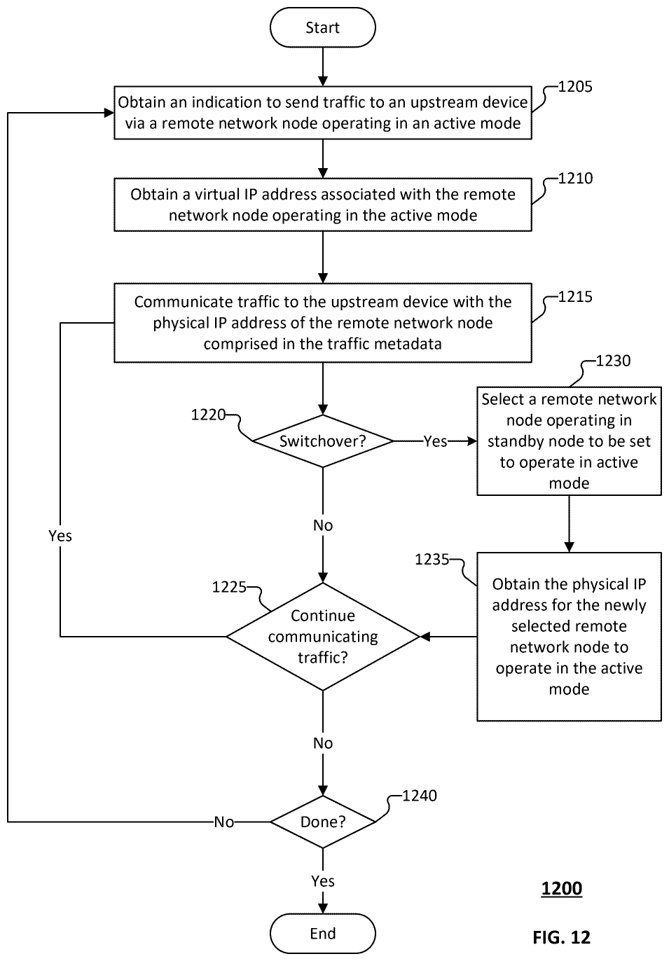

FIG. 12 is a flow diagram of a method for handling a switchover or failover according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity (or security device) is a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application. The security entity may communicate with a cloud service (e.g., security platform 140) to perform workloads such as to provide security services.

A security entity (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

In cloud based environments, supporting device switchovers is a critical functionality. Upstream (or even downstream) network elements need to react to such switchovers and send data packets to the correct device following the switchover. We propose a novel and simple way for upstream devices to handle such switchovers in the invention described below.

A device switchover or device failover in cloud computing may refer to the ability to automatically transition workloads, applications, or data streams from a failed or compromised instance to a standby or secondary instance. This process is generally required to be instantaneous or near-instantaneous to ensure that end-users experience little to no disruption.

The complexity of implementing effective failover mechanisms in cloud environments arises from several factors:
Distributed Architecture: Cloud services are typically spread across multiple data centers and regions, necessitating a comprehensive strategy to manage state and data consistency during failover.
Resource Elasticity: Cloud environments are inherently elastic, with resources being dynamically allocated and deallocated. This requires failover systems to be adaptive and capable of handling changing resource landscapes.
Diverse Workloads: The variety of applications and services running in the cloud—from databases to web servers to AI models-means that failover solutions must be versatile and customizable to different workload requirements.
Latency and Performance: Minimizing latency during failover is crucial. Solutions must ensure that the transition is not only smooth but also rapid enough to maintain performance benchmarks and user satisfaction.

Related art systems can implement a wide variety of protocols and technologies (e.g., Hot Standby Router Protocol (HSRP), Virtual Router Redundancy Protocol (VRRP), etc.) that address the problem of device redundancy via mechanisms such as gratuitous Address Resolution Protocol (ARP) for discovery, multicast groups for sending updates or electing leaders and so on. Additionally, or alternatively, related art cloud providers may support floating public IPs that can facilitate switchovers by providing simple forwarding rules. However, handling device switchovers is challenging for cloud based solutions that use private IP address space for the devices or are composed of devices that may not have the support to implement such protocols.

Various embodiments implement the handling of switchovers or failovers of traffic carrying devices (e.g., a set of network nodes) that work in an active-standby mode based at least in part on generating (e.g., assigning) a virtual routing address (e.g., a virtual IP address) that is common to the traffic carrying devices, and sending the actual physical IP address (e.g., of the traffic carrying device operating in the active mode, or the traffic carrying device to which a response is to be sent) as additional metadata associated with (e.g., embedded in) a packet to upstream devices/routers. According to various embodiments, the responses that are sent back from the upstream service (e.g., the upstream device processing the workload or request) will use the physical IP address (e.g., extracted from the metadata associated with the packet) as the destination IP for routing.

Various embodiments provide a method, system, and computer system for managing failovers of network devices operating in an active-standby node. The method includes (i) generating, by one or more processors a virtual routing IP address that is common to a plurality of network nodes, and (ii) sending to an upstream device a physical IP address for a particular network node (e.g., the active network node) of the plurality of network nodes, wherein the physical IP address is sent as metadata in a packet to the upstream device

Various embodiments implement AI and machine learning models to monitor system health (e.g., health of the active network nodes) and predict failures before they occur. The system stores a key-pair value mapping to map the virtual IP address associated with traffic being processed by the upstream device to an active node/device. In response to predicting that a failover will occur, the system updates a key-value mapping at a particular upstream device (e.g., a worker node) to map the virtual IP address associated with traffic being processed by the upstream device to a physical IP address associated a new active node such as the physical IP address associated with the switchover or failover device (e.g., the network node operating in a standby mode, which is set to operate in an active mode when a current active mode fails or is predicted to fail).

Various embodiments provide sophisticated failover solutions that can support high availability in cloud environments. These solutions are designed to detect potential failures, initiate switchover processes, and seamlessly transfer operations to backup systems (e.g., standby network nodes), all with minimal or no human intervention.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

Various embodiments provide a method, system, and device for a network node to communicate with a cloud service, such as a virtualized firewall, to perform a security service. The network node (e.g., a firewall or data appliance) can communicate with the cloud service to obtain the security service, such as to have a domain, traffic, or file classified. The cloud service may implement one or more servers or clusters of virtual machines or other worker nodes to process the workload for the network node (e.g. to perform the classifications in connection with providing the security service). Additionally, or alternatively, the system implements the virtual firewall as a network node that communicates with a set of worker nodes to provide a service.

As used herein, a network node can include a virtualized firewall, a security entity, or other network node configured to connect to a service or set of worker nodes (e.g., a cluster of virtual machines) to request a workload to be processed.

FIG. 1 is a block diagram of an environment for providing a security service according to various embodiments. In some embodiments, system 100 implements at least in part of system 200 of FIG. 1 and/or system 300 of FIG. 3. System 100 can implement at least part of one or more of processes 400-1200 of FIGS. 4-12.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

In some embodiments, data appliance 102 is a security entity, such as a firewall (e.g., a next generation firewall). An enterprise network (e.g., a network for a tenant serviced by security platform 140) may comprise a set of data appliances 102 (e.g., a set of network nodes).

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a DNS hijacked domain, etc.), classifying network traffic, providing a mapping of signatures to certain domains (e.g., domains for which a predicted likelihood that the domain is a DNS hijacked domain exceeds a predefined likelihood threshold, etc. a mapping of domains to domain data (e.g., domain certificates, pDNS data, active DNS data, WHOIS data, etc.), performing static and dynamic analysis on malware samples, monitoring new domains (e.g., detecting new domains for which a certificate is issued/generated), assessing maliciousness of domains, determining whether a domain associated with a traffic sample is (or is likely to be) a DNS hijacked domain, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain, a DNS hijacked domain) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, or domain is malicious (or benign), simulating DNS hijacking attacks/campaigns (e.g., generating synthetic DNS hijacking records), and training classifiers (e.g., training machine learning models, such as to be used to provide inline detection of DNS hijacked domains, or offline detection of DNS hijacked domains).

In some embodiments, security platform 140 is deployed as a cloud service. For example, security platform 140 may be implemented by one or more servers and may comprise one or more clusters of worker nodes (e.g., virtual machines).

In some embodiments, security platform 140 classifies the network traffic, files, or domains in response to receiving a network traffic sample or according to a predefined schedule. For example, security platform 140 can perform the classification as the endpoint or network entity (e.g., a firewall or data appliance 102) detects traffic for a new domain, traffic to/from a suspicious domain, a new file, etc. In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In the example shown, security platform 140 comprises DNS tunneling detector 138 and domain classifier 170 to provide security services, such as to security entities (e.g., firewalls, etc.). According to various embodiments, security platform 140 may perform various other security services. Security platform 140 may implement a machine learning model(s) to perform classifications, such as to predict whether a domain is malicious or hijacked, predict whether a file is malicious, etc. Additionally, security platform 140 may train the machine learning model(s) to perform the classifications.

In some embodiments, domain classifier 170 detects/classifies a domain. For example, domain classifier 170 predicts whether a particular domain (e.g., a candidate domain) is a DNS hijacked domain. In some embodiments, domain classifier 170 additionally predicts whether a particular domain is a malicious domain or a DNS hijacked domain. In some embodiments, domain classifier 170 classifies the domain based at least in part on a signature of the candidate domain, such as by querying a mapping of signatures to domain identifiers (e.g., a set of previously analyzed/classified applications). As an example, domain classifier 170 uses a signature or domain identifier to query a blacklist of domains to check whether the candidate domain is on the blacklist of domains. In some embodiments, domain classifier 170 classifies the domain based on a predicted domain classification (e.g., a prediction of whether a candidate domain is a DNS hijacked domain, whether the candidate domain is a malicious domain, or whether the candidate domain is benign, etc.). For example, domain classifier 170 determines (e.g., predicts) the domain classification based at least in part on domain data for the candidate domain. Examples of domain data include a certificate information pertaining to a certificate(s) associated with the candidate domain (e.g., the domain associated with the particular domain request), registration information, pDNS data, geolocation data, scan data, active DNS information, zone file information, Whois registry data, web crawled data (e.g., data obtained by crawling the website), etc.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding domain (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system to detect perform a failover to another network node according to various embodiments. In some embodiments, system 200 implements at least in part of system 100 of FIG. 1 and/or system 300 of FIG. 3. System 200 can implement at least part of one or more of processes 400-1200 of FIGS. 4-12.

System 200 can be implemented by one or more devices such as servers. System 200 can be implemented at various locations on a network. In some embodiments, system 200 implements a system for communicating traffic between a data appliance such as a security entity (e.g., data appliance 102) and security platform 140 of FIG. 1. As an example, system 200 is deployed as a service to ensure that network traffic for a particular tenant or set of nodes is forwarded/directed to a particular upstream device such as a worker node or other virtual machine comprised in a cluster that implements a cloud-based security service (e.g., security platform 140). System 200 is configured to maintain the connection between a set of network nodes (e.g., the security entities) for a tenant and a particular upstream device assigned to process a workload for the set of network nodes.

The upstream service may be provided by one or more servers or one or more virtual machines or worker nodes. For example, the upstream service is deployed on a remote server(s) that monitors or receives network traffic that is transmitted within or into/out of a network and determines the traffic classification (e.g., whether the traffic is malicious traffic, such as traffic to/from a domain classified as a DNS hijacked domain, whether the traffic is non-malicious, such as traffic to/from a domain that is not classified as a DNS hijacked domain or that is classified as a benign domain, etc.) and sends/pushes out notifications or updates pertaining to the network traffic such as an indication of the domain to which the network traffic corresponds or an indication of whether an domain is DNS hijacked or otherwise malicious.

In some embodiments, system 200 configures network traffic communicated by a set of network nodes (e.g., security entities such as firewalls or other data appliances) for a tenant to identify as the source IP a virtual IP address that is common to all network nodes in the set of network nodes. System 200 may further configure the network traffic to comprise the actual physical IP address for the network node to which the upstream service is to send the response data.

In some embodiments, system 200 ensures that traffic associated with a particular virtual IP address is forwarded/redirected to an appropriate upstream device (e.g., a particular worker node of the upstream service). For example, system 200 maintains a mappings based on virtual IP addresses to a particular upstream device, and forwards the network traffic to the particular upstream device in response to intercepting the network traffic and querying the mappings. System 200 may use a mappings of tuples to upstream devices to maintain the association between the virtual IP address for the set of network nodes and the upstream device to provide the upstream service. The tuple may be based at least in part on the virtual IP address and all network traffic from the set of network nodes associated with the virtual IP address have a same corresponding tuple.

In some embodiments, system 200 maintains a mapping of a virtual IP address to a particular physical IP address for a particular network node (e.g., comprised in the set of network nodes) to which the upstream service (e.g., the upstream device that is processing the workload for the network traffic) sends response data. For example, the upstream device may store a key-value pair that maps the virtual IP address to the appropriate physical IP address. In response to determining that response data is to be returned to a network node, the upstream device may query the key-value pair to determine the network node to which to send the response data, and configure the destination address for the response data to be the physical IP address comprised in the key-value pair for the virtual IP address.

In the example shown, system 200 implements one or more modules in connection with ensuring that a connection is maintained through the failover or switchover of an active network node to a standby network node, etc. System 200 comprises communication interface 205, one or more processors 210, storage 215, and/or memory 220. One or more processors 210 comprises one or more of communication module 225, virtual IP mapping module 227, physical IP obtaining module 229, packet generation module 231, upstream device determining module 233, virtual IP to physical IP mappings module 235, network traffic redirection module 237, key-value pair management module 239, switchover module 241, keepalive module 243, workload processing module 245, and response module 247.

In some embodiments, system 200 comprises communication module 225. System 200 uses communication module 225 to communicate with various nodes or end points (e.g., client terminals, firewalls, DNS resolvers, data appliances, other security entities, cloud services, upstream services, worker nodes, etc.), and/or third-party services (e.g., a certificate authority service, a network/internet crawler or scanner, a pDNS service, a geolocation service, and/or a registrar service provider, such as a WHOIS service, etc.) For example, communication module 225 provides to communication interface 205 information that is to be communicated (e.g., to another node, security entity, etc.).

In some embodiments, system 200 comprises virtual IP mapping module 227. System 200 uses virtual IP mapping module 227 to associate a virtual IP address to a set of network nodes (e.g., a set of network nodes, such as security entities deployed in an enterprise network). For example, virtual IP mapping module 227 associates the virtual IP address to a set of network nodes for a particular tenant. Virtual IP mapping module 227 may determine the virtual IP address(es) to be mapped to tenants based at least in part on a predefined algorithm that ensures the virtual IP address is unique among nodes for the tenant or across a set of tenants. In response to determining the virtual IP address, virtual IP mapping module 227 can store the association between the virtual IP address to the set of network nodes (e.g., for the tenant) in a mapping of virtual IP addresses to sets of network nodes (or to tenants). In some embodiments, system 200 uses the virtual IP address assigned or mapped to the set of network nodes to be common for the set of network nodes.

In some embodiments, system 200 comprises physical IP obtaining module 229. System 200 uses physical IP obtaining module 229 to obtain a physical IP address for a particular device. A set of network nodes (e.g., network nodes) for a tenant may operate in active-standby modes, with a particular network node serving as the active network node at any given time and the remaining set of network nodes being configured to operate in a standby mode. Physical IP obtaining module 229 may determine the physical IP address for the then-current active network node (e.g., the firewall operating in the active mode).

According to various embodiments, physical IP obtaining module 229 is comprised in the active network node. The active network node can obtain its physical IP address and communicate the physical IP address as metadata for the network traffic to be sent to, and processed by, the upstream service.

In some embodiments, system 200 comprises packet generation module 231. System 200 uses packet generation module 231 to generate a packet to be communicated from the then-active network node (e.g., the firewall operating in active mode) to the upstream service. Packet generation module 231 configures the packet(s) to set the source IP to be equal to the virtual IP address. System 200 uses the configuration of the source IP to be the virtual IP address to maintain a connection between the set of network nodes and the upstream service through failure of an active network node and switchover to another network node (e.g., the switchover to cause a standby network node to be set to operate in the active mode).

In some embodiments, system 200 comprises upstream device determining module 233 and virtual IP to physical IP mappings module 235. According to various embodiments, upstream device determining module 233 is implemented by a load balancer or other service that intercepts and/or mediates traffic between the set of network nodes and the upstream service. The virtual IP to physical IP mappings module 235 may additionally be comprised in the load balancer or other service, or alternatively, be comprised in a service or system that can be queried by upstream device determining module 233.

In some embodiments, the virtual IP address to physical IP address mapping is communicated in packet metadata for traffic between a network node and an upstream service.

System 200 uses upstream device determining module 233 to determine the particular upstream device (e.g., from among a set of upstream devices implemented by an upstream service) to which to send the network traffic from the set of network nodes (e.g., to send the packet generated by packet generation module 231). Upstream device determining module 233 may determine the particular upstream device based at least in part on information comprised within the network traffic, such as the virtual IP address comprised in the source IP field for the packet.

In some embodiments, upstream device determining module 233 determines the particular upstream device by using the virtual IP address obtained from the network traffic (e.g., by extracting the source IP) to query virtual IP to upstream device mappings module 233. Virtual IP to upstream device mappings module 233 may store associations between virtual IP addresses and upstream devices, such as in tuple data 265. In some embodiments, the associations between virtual IP addresses and upstream devices comprises a mappings of tuples to upstream devices, where the tuple is based at least in part (e.g., comprises) the virtual IP address. If the upstream device determining module 233 determines that virtual IP to upstream device mappings module 233 does not comprise a mapping for the virtual IP address, upstream device determining module 233 can assign the virtual IP address to a particular upstream device using a predefined assignment algorithm, such as a load-balancing protocol or algorithm. In response to assigning the virtual IP address to a particular upstream device, virtual IP to upstream device mappings module 233 can update the mappings to comprise an association between the virtual IP address and the particular upstream device.

In some embodiments, system 200 comprises network traffic redirection module 237. According to various embodiments, network traffic redirection module 237 is implemented by a load balancer or other service that intercepts and/or mediates traffic between the set of network nodes and the upstream service. System 200 uses network traffic redirection module 237 to redirect network traffic to the appropriate upstream device. In response to determining the particular upstream device to which the virtual IP address (e.g., the virtual IP address associated with the network traffic, such as extracted from the source IP field) is mapped, network traffic redirection module 237 forward the network traffic to the upstream device for processing.

In some embodiments, system 200 comprises key-value pair management module 239. According to various embodiments, key-value pair management module 239 is implemented by an upstream device (e.g., the upstream device processing the workload) or the upstream service generally (e.g., by control node that controls a set of worker nodes/upstream devices deployed in the upstream service). System 200 uses key-value pair management module 239 to map virtual IP addresses to physical IP addresses. The physical IP addresses to which a virtual IP address is mapped corresponds to the actual physical IP address for the network node to which response data is to be returned (e.g., the network node currently operating in the active mode). In response to receiving a packet (e.g., a first packet) from an active network node, key-value pair management module 239 may store (e.g., in VIP-to-PIP data 270) the key-value pair or mapping of the virtual IP address to the physical IP address for the active network node. Key-value pair management module 239 may continually or periodically monitor whether the physical IP address comprised in the packet (e.g., extracted from the optional header or other metadata of the packet) has changed. In response to the physical IP address sent in connection with the packet changing or a failover being performed to a new active network node, key-value pair management module 239 can update the mapping/association for the virtual IP address.

In some embodiments, system 200 comprises switchover module 241. System 200 uses switchover module 241 to perform a switchover from a current active network node to another network node in the set of network nodes (e.g., a set of nodes for a tenant, such as a set of firewalls). For example, switchover module 241 selects a network node currently operating in standby mode to be configured to operate in active mode in response to determining that the-current active network node has failed or otherwise determining the perform a switchover to a new active network node.

In some embodiments, system 200 comprises keepalive module 243. According to various embodiments, keepalive module 243 is implemented by an upstream device (e.g., the upstream device processing the workload) or the upstream service generally (e.g., by control node that controls a set of worker nodes/upstream devices deployed in the upstream service). System 200 uses keepalive module 243 to monitor whether the active network node (e.g., the network node for the physical IP address then-currently mapped to the virtual IP address) and determine whether the active network node has failed. The keepalive module 243 may send a heartbeat signal or random/empty packets to the active network node to ensure that the active network node is operating normally or to ensure quick detection of a failure so the key-value pair mapping for the virtual IP address can be promptly updated to reflect the physical IP address to the switchover network node.

In some embodiments, system 200 comprises workload processing module 245. According to various embodiments, workload processing module 245 is implemented by an upstream device (e.g., the upstream device processing the workload). System 200 uses workload processing module 245 to process a workload corresponding to requests or network traffic received from the set of network nodes (e.g., to perform traffic classifications or malicious traffic detections, etc.). Workload processing module 245 determines a response data for the workload.

In some embodiments, system 200 comprises response module 247. System 200 uses response module 247 to send the response data to the appropriate network node (e.g., the then-active network node). Response module 247 configures the destination address for the response data to be equal to the physical IP address mapped to the virtual IP address associated with the workload/response data.

According to various embodiments, storage 215 comprises one or more of IP address data 260, tuple data 265, and/or VIP-to-PIP data 270 (e.g., virtual IP address to physical IP address data). Storage 215 comprises a shared storage (e.g., a network storage system) and/or database data, and/or user activity data. IP address data 260 can store one or more of a virtual IP address associated with a particular tenant or set of network nodes, physical IP addresses for the set of network nodes, etc. Tuple data 265 stores mappings of tuples to upstream devices (or addresses for upstream devices). VIP-to-PIP data 270 stores mappings of virtual IP addresses to physical IP addresses to which corresponding response data is to be communicated. For example, the VIP-to-PIP data 270 comprises the key-value pairs for virtual IP addresses.

According to various embodiments, memory 220 comprises executing application data 275. Executing application data 275 comprises data obtained or used in connection with executing an application such as an application executing a hashing function, an application to extract information from webpage content, an application to collect domain data, an application to monitor certificate logs, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious input strings, suspicious files, an application for detecting suspicious or DNS hijacked domains, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIGS. 3A and 3B are an illustration of a system for performing a failover to another network node according to various embodiments. In some embodiments, system 300 is implemented at least in part by system 100 of FIG. 1 and/or system 200 of FIG. 2. System 300 can implement at least part of one or more of processes 400-1200 of FIGS. 4-12.

In the example shown, system 300 comprises client system 305, a set of network nodes (e.g., first network node 310, second network node 315, etc.), load balancer 320, and a set of worker nodes or other upstream devices. The set of worker nodes or other upstream devices may comprise worker node 1 325, worker node 2 330, worker node 3 335, worker node 4 340, and/or worker node 5 345. In some embodiments, the set of worker nodes comprise a set of virtual machines for a cluster of virtual machines, such as a cluster that is configured or used for performing network traffic classifications or to process other security service workloads.

Client system 305 may connect to first network node 310 and second network node 315 in connection with a session or to otherwise request an upstream service (e.g., to cause the upstream service to process a particular workload) comprising the set of worker nodes or other upstream devices. Client system 305 may be authenticated in connection with a particular tenant serviced by the set of network nodes. In some embodiments, the network nodes are security entities such as firewalls (e.g., next generation firewalls).

In some embodiments, the set of network nodes operate in an active-standby mode. As an example, at any particular time only the network node operating in active mode is transmitting and receiving packets from an upstream device (e.g., an upstream service). The set of network nodes may comprise a set of firewalls that collectively provide a security service to client system 305 and can request an upstream service (e.g., a maliciousness classification, a dynamic analysis of a file or network traffic packet, etc.) from the set of worker nodes or upstream devices. The physical IP addresses of first network node 310 and second network node 315 may be denoted as P1 and P2, respectively.

In some embodiments, system 300 assigns/allocates a virtual IP address (VIP) to a particular tenant or set of network nodes. For example, system 300 assigns a virtual IP address (e.g., V1) that is unique among the set of network nodes. System 300 can determine the virtual IP address by generating the virtual IP address using a predefined mathematical function in such a way that V1 is non-repeating when generated by any network node x (e.g., firewall Fx) where x≠1,2.

System 300 uses the virtual IP address (e.g., V1) in connection with communicating traffic to the upstream service (e.g., the set of worker nodes, etc.). System 300 (e.g., the particular network node, such as the active network node operating in active mode) can configure the source IP for the network traffic to be equal to the virtual IP address. For example, system 300 sets V1 in the source IP field of the IP packet header by the applicable network node (e.g., firewall F1 or firewall F2) when it is actively transmitting. When a switch over occurs to a standby network node, such network node can continue to use the virtual IP address for traffic communicated to the upstream service. The transmission of traffic (e.g., the packet) with the source IP set to the assigned virtual IP address (e.g., V1) instead of the corresponding physical IP address of the active network node (e.g., P1 or P2 itself) enables correct traffic handling in cases where there are intermediate devices such as load balancers (e.g., Google's Internal Load Balancer) are positioned between the set of network nodes and the upstream service. The stickiness to a destination in such cases is determined by the source IP of the packet. Accordingly, switching between physical addresses of the network nodes (e.g., P1 and P2) might break the TCP connection to the upstream device (e.g., device D) processing the request/workload.

In some embodiments, system 300 communicates to the upstream service the physical IP address (e.g., P1 or P2) for the network node operating in the active mode or the network node to which a response from the upstream service is to be provided. For example, system 300 sends the physical IP address sent as a part of additional packet data. The physical IP address could be sent as a part of TCP options in a custom type-length-value (TLV) in a TCP based, non-tunneled environment, or as a part of the tunnel header extensions (e.g., GENEVE options for the Generic Network Visualization Encapsulation protocol) in a tunneled packet to the upstream device.

In response to the upstream device (e.g., device D) receiving the network traffic (e.g., the first packet) from the active network node (e.g., the active firewall, for example F2), system 300 (e.g., the upstream device) creates a key-value map (e.g., FWMAP) as a software construct with the virtual IP address (e.g., V1) as the key and the physical IP address of the network node (e.g., P2) as the value. Additionally, in response to the upstream device receiving network traffic associated with the virtual IP address, system 300 can update a corresponding key-value map if the physical IP address in the network traffic is different from the existing physical IP address in the key-value map such as in the case of a failover from the network node operating in active mode (e.g., F2) to another network node that was operating in standby mode (e.g., F1).

In some embodiments, the network traffic (e.g., the packet) is processed at the upstream device (e.g., device D) and when a response is to be sent out back to the applicable network node (e.g., the active firewall), system 300 (e.g., the upstream device) performs a map lookup (e.g., using the key-value pair/map) to determine the destination IP address, which in the example above is P2. According to various embodiments, in cloud environments where the destination MAC address of a gateway is not sufficient for the underlay network to route packets back to the firewalls (e.g., the network nodes), the system may further encode the source MAC address in the additional packet data (e.g., as metadata), along with the physical IP address of the sender.

In some embodiments, when a switchover (e.g., a failover) of the network node (e.g., firewall) operating in the active mode occurs (e.g., from firewall F2 to firewall F1), network, the network traffic will then be sent from the network node then operating in the active mode (e.g., firewall F1). Accordingly, system 300 configures the packets for the network traffic to set the source IP to the virtual IP address for the tenant or set of network nodes, and to comprise an indication of the physical IP address for the network node then operating in the active mode. System 300 can persist the connection (e.g., maintain a sync between the active and standby firewall) between the set of network nodes and the upstream device by maintaining the virtual IP address as the source IP while communicating (e.g., as metadata) the actual physical IP address of the network node to receive a response data (e.g., the network node operating in the active mode) as metadata to the packets. When the upstream device (e.g., device D) receives a packet from the network node operating in the active mode to which the communication has switched over, system 300 (e.g., the upstream device) updates the value for the virtual IP address (e.g., V1) in the key-value pair mapping of virtual IP addresses to physical addresses to correspond to the physical IP address for the network node operating in the active mode to which the communication has switched over (e.g., firewall F1). After correspondingly updating the mapping of virtual IP addresses to physical IP addresses (e.g., after updating the key-value pair for the virtual IP address), system 300 sends responses back to the active network node using the physical IP address for the then-active network nod as the destination IP address.

In the example shown in FIG. 3A using communication path 360, client system 305 communicates a request to system 300 via first network node 310, which transmits a packet to the upstream service. Load balancer 320 may intercept the packet and determine the particular upstream device (e.g., the worker node selected from a cluster of worker nodes) to which to send the packet for processing. Load balancer 320 may determine the particular upstream device to send (e.g., forward/redirect) the packet based at least in part on the virtual IP address associated with the packet (e.g., inserted as the source IP in the packet header). For example, load balancer 320 determines a tuple (e.g., a 5-tuple) based on information extracted from the packet, and determines the upstream device mapped to the tuple, or if system 300 does not store an existing mapping of the tuple to an upstream device, then load balancer 320 selects an upstream device from among the set of upstream devices (e.g., the cluster of worker nodes 1-5 325-345) and stores an assignment or mapping of the tuple to the selected upstream device for future reference when mediating traffic from network nodes to the set of upstream devices. As shown, load balancer 320 determines to send the packet (e.g., communicated along communication path 360) to worker node 3 335.

In the event that first network node 310 (e.g., the then-current active node) fails or system 300 otherwise determines to perform a switchover, second network node 315 (e.g., a then-current standby node) is selected to operate in active mode. Accordingly, system 300 sends future packets along communication path 370. The traffic (e.g., the packet) sent from second network node 315 is configured to have the source IP set to be the virtual IP address for the set of network nodes (e.g., the virtual IP address assigned to associated tenant) and to indicate the actual physical IP address for second network node 315. For example, the actual physical IP address may be inserted as metadata for the traffic, such as embedded in an optional header or other data structure. As illustrated in FIG. 3B, when load balancer 320 intercepts the traffic communicated from second network node 315, load balancer 320 continues to direct traffic from the set of network nodes to the same upstream device-worker node 3 335. When load balancer 320 computes the tuple associated with traffic over communication path 370, load balancer 320 queries the mappings of tuples to upstream devices and finds the mapping previously used for communication path 360 and finds worker node 3 335 as being mapped to the tuple. Because the source IP has been set to the virtual IP address that is common to the set of network nodes, the tuples computed for communication path 360 and communication path 370 are the same. For example, the source IP, or virtual IP address, is used to compute the tuples rather than the actual physical IP addresses for the network nodes from which the traffic is received.

Although the key-value pair for the virtual IP address (e.g., comprising the mapping of the virtual IP address to the physical IP address for the network node to which response data is to be returned) is updated in response to a switchover, such as when the newly active network node (e.g., second network node 315 in the example above) sends a first packet to the upstream device, a set of one or more packets received by the upstream device from the previous active network node (e.g., the network node that failed) before the switchover may be pending for response data to be returned by the upstream device. The upstream device may attempt to send the response data to the physical IP address for the previous active network node and upon the updating of the key-value pair, the upstream device may correspondingly update the destination address for the pending packets for further retry traffic attempts.

In some embodiments, the upstream device processing a workload for a set of network nodes (e.g., a tenant) may perform a keepalive or heartbeat mechanism in connection with monitoring a health of the network node currently mapped to the virtual IP address (e.g., the network node corresponding to the physical IP address to which response data is to be returned). The upstream device may perform the keepalive or heartbeat mechanism while it is processing the workload (e.g., before sending the response data). In response to detecting that the network node has failed or is otherwise unresponsive based on the keepalive or heartbeat mechanism, system 300 (e.g., the upstream device) can update the destination address for the response data to correspond to the physical IP address to the network node to which a switchover is to occur. For example, the upstream device updates the key-value pair for the virtual IP address. The keepalive mechanism may include sending packets to the network node (e.g., the physical IP address then-mapped to the virtual IP address) to see if the network node is alive or healthy (e.g., regardless of application).

FIG. 4 is a flow diagram of a method for communicating network traffic in a manner that ensures that traffic is properly routed in the event of a switchover or failover according to various embodiments. In some embodiments, process 400 is implemented at least in part by system 100 of FIG. 1, system 200 of FIG. 2, and/or system 300 of FIGS. 3A-3B. Process 400 may be implemented by an inline security entity.

In some implementations, process 400 is implemented by one or more servers, such as in connection with providing a service to a network (e.g., a security entity and/or a network endpoint such as a client device). In some implementations, process 400 may be implemented by a security entity (e.g., a firewall) such as in connection with enforcing a security policy with respect to traffic from/to domains across a network or in/out of the network. In some implementations, process 400 may be implemented by a client device such as a laptop, a smartphone, a personal computer, etc., such as in connection with executing or opening a file such as an email attachment.

At 405, the system generates a virtual routing IP address that is common to a plurality of network nodes. In some embodiments, the system assigns a virtual IP address to a group of network node workers that are associated with a particular workload or a particular session (e.g., a session associated with a client system's access of a network). At 410, the system sends to an upstream device a physical IP address for a particular network node of the plurality of network nodes. In some embodiments, the system selects a network node that is to receive a response to a request (e.g., a request for the upstream device to perform a workload) and the system sends to the upstream device the physical IP address for the selected network node. The plurality of network nodes may include a network node operating in active mode and a remaining set of network nodes operating in standby mode. The network node selected to receive the response may correspond to the network node that is operating in active mode. At 415, a determination is made as to whether process 400 is complete. In some embodiments, process 400 is determined to be complete in response to a determination that no further network traffic is to be communicated between the plurality of network nodes and the upstream device, a workload for the plurality of network nodes is complete, an administrator indicates that process 400 is to be paused or stopped, etc. In response to a determination that process 400 is complete, process 400 ends. In response to a determination that process 400 is not complete, process 400 returns to 405.

FIG. 5 is a flow diagram of a method for communicating network traffic in a manner that ensures that traffic is properly routed in the event of a switchover or failover according to various embodiments. In some embodiments, process 500 is implemented at least in part by system 100 of FIG. 1, system 200 of FIG. 2, and/or system 300 of FIGS. 3A-3B. Process 500 may be implemented by an inline security entity.

In some implementations, process 500 is implemented by one or more servers, such as in connection with providing a service to a network (e.g., a security entity and/or a network endpoint such as a client device). In some implementations, process 500 may be implemented by a security entity (e.g., a firewall) such as in connection with enforcing a security policy with respect to traffic from/to domains across a network or in/out of the network. In some implementations, process 500 may be implemented by a client device such as a laptop, a smartphone, a personal computer, etc., such as in connection with executing or opening a file such as an email attachment.

At 505, the system obtains an indication to send a packet to an upstream device. The system determines to send the packet to an upstream device in response to determining that the upstream device is to process a workload or otherwise provide a service to the client system (e.g., via the network node operating in the active mode). As an example, the upstream device may comprise a virtual machine that can process a workload associated with performing a maliciousness classification for a traffic sample provided by a network node.

At 510, the system obtains a virtual IP address. The system can first determine whether a virtual IP address has been assigned/allocated to a particular tenant (e.g., tenant with which the client system accessing the network node is associated), workload, session, or set of network nodes, such as by querying a mappings of sessions to virtual IP addresses. If a virtual IP address has been previously assigned, the system obtains the virtual IP address (e.g., from the mapping). If a virtual IP address has not been previously assigned, the system generates a virtual IP address to be assigned, the virtual IP address being unique across tenants and/or network nodes. For example, the system ensures that the virtual IP address is different from the physical IP addresses of the network nodes within the particular tenant or other tenants.

At 515, the system obtains a physical IP address. In some embodiments, the system selects a node that is to receive a response to a request (e.g., a request for the upstream device to perform a workload) and the system obtains the physical IP address for the selected network node. The plurality of network nodes may include a node operating in active mode and a remaining set of network nodes operating in standby mode. The network node for which the physical IP address is obtained may correspond to the network node that is operating in active mode. In some embodiments, the system obtains the physical IP address for the network node from which traffic is to be sent to the upstream device for processing.

At 520, the system generates a packet configured to comprise the virtual IP address as the source IP address, and to further comprise the physical IP address in metadata for the packet.

In some embodiments, the packet is configured according to a predefined protocol such as the Transmission Control Protocol (TCP). In this configuration, the virtual IP address is set as the source IP in the IP header, ensuring consistent endpoint addressing. Meanwhile, the physical IP address (e.g., of the selected network node to receive a response, or the network device from which the traffic is originating) is embedded in an optional header or extension field, providing necessary metadata for internal network management.

Various embodiments may implement various other protocols for similar configurations. For instance, the User Datagram Protocol (UDP) can be used when low latency is prioritized over guaranteed delivery, making it suitable for real-time applications such as voice and video streaming. In UDP traffic, the physical IP address may be carried as part of the Geneve TLV extension. The Internet Control Message Protocol (ICMP), often used for diagnostic or control purposes like the ping command, can similarly be adapted to include a virtual IP address in the main header and a physical IP address in an extension. Another example is the Stream Control Transmission Protocol (SCTP), which supports multi-homing and redundancy, making it well-suited for applications requiring robust failover capabilities.

At 525, the system sends the packet. The system communicates the packet to the upstream device, or a service that comprises a set of upstream devices to process the packet/request.

At 530, a determination is made as to whether process 500 is complete. In some embodiments, process 500 is determined to be complete in response to a determination that no further network traffic is to be communicated between the plurality of network nodes and the upstream device, a workload for the plurality of network nodes is complete, an administrator indicates that process 500 is to be paused or stopped, etc. In response to a determination that process 500 is complete, process 500 ends. In response to a determination that process 500 is not complete, process 500 returns to 505.

FIG. 6 is a flow diagram of a method for routing network traffic in a manner that ensures that traffic is properly routed in the event of a switchover or failover according to various embodiments. In some embodiments, process 600 is implemented at least in part by system 100 of FIG. 1, system 200 of FIG. 2, and/or system 300 of FIGS. 3A-3B.

In some implementations, process 600 is implemented by one or more servers, such as in connection with providing a service to a network (e.g., a security entity and/or a network endpoint such as a client device). In some implementations, process 600 may be implemented by a load balancing service (e.g., one or more servers that provide load balancing to a set of worker nodes or other upstream devices, etc.).

At 605, the system obtains a packet from a network node. In some embodiments, the system intercepts the packet being communicated from the network node to an upstream device or upstream service comprising a set of upstream devices (e.g., a cluster of virtual machines).

At 610, the system obtains information associated with the packet. For example, the system parses the packet and extracts the information such as the source IP and other metadata embedded within the packet.

At 615, the system determines a tuple based at least in part on the information associated with the packet. The system generates the tuple according to a predefined protocol comprising a particular set of data extracted from the packet. In some embodiments, the tuple is a 5-tuple.

In networking, a 5-tuple is a set of five distinct values that uniquely identifies a network connection or session between two endpoints (e.g., a network comprising a set of network nodes operating in active-standby modes and an upstream service comprising a set of upstream devices). These values are typically used in the context of transport layer protocols such as TCP and UDP to define a communication flow. Together, these five elements in the 5-tuple provide a comprehensive way to identify and manage individual network flows, allowing routers, switches, firewalls, load balancers, and other network devices to apply specific rules and policies to different streams of traffic. The 5-tuple can be implemented for tasks such as quality of service (QOS) management, traffic shaping, network security, and monitoring. In some embodiments, components of a 5-tuple are:
Source IP Address: Generally, the source IP address is IP address of the device that initiates the connection. In some embodiments, the virtual IP address assigned to the tenant, workload, or session, etc. is used as the source IP address to ensure that when the 5-tuple is used to direct traffic to a particular upstream device all traffic associated with the virtual IP address (e.g., all traffic collectively from a set of network nodes for a tenant) is passed/redirected to a particular upstream device.
Destination IP Address: The IP address of the device that receives the connection. In some embodiments, the destination IP address is the IP address of the upstream device (e.g., the particular virtual machine in a cluster of virtual machines) that is assigned/selected to process the request or workload for the client system or tenant with which the client system is associated, etc.
Source Port Number: The port number on the source device from which the communication originates.
Destination Port Number: The port number on the destination device to which the communication is directed.
Protocol: The transport layer protocol being used for the communication, such as TCP or UDP.

At 620, the system determines an upstream device to forward the packet based at least in part on the tuple. In some embodiments, the system assigns a tuple to a particular upstream device (e.g., a virtual machine among a cluster of virtual machines) to ensure that traffic associated with the tenant can be consistently directed to the particular upstream device. To determine the upstream device, the system can query a mapping of tuples to upstream devices to determine whether the tuple has previously been assigned/mapped to a particular upstream device and, if so, to determine the particular upstream device to which to forward the packet. If the mapping of tuples to upstream devices does not comprise a record or mapping for the tuple, the system can assign (e.g., allocate traffic for) the tuple to a particular upstream device. The assignment/mapping of the tuple to the particular upstream device (e.g., a particular IP address for the upstream device) can be stored in the mappings of tuples to upstream devices for future reference.

In some embodiments, the system implements a load balancing to assign the tuple to a particular upstream device. The load balancing can be designed to efficiently manage and distribute network traffic across a set of upstream devices, such as a cluster of virtual machines (VMs) or servers. By generally evenly spreading the workload, the load balancing ensures optimal resource utilization, improved response times, and increased reliability of applications and services.

In some embodiments, the system implementing load balancing (e.g., the load balancer) receives incoming network traffic from clients (e.g., a network node operating in an active mode) seeking to access an application or service. This traffic could come in the form of HTTP/HTTPS requests, database queries, or other types of network communications. The load balancer continuously monitors the health and status of all VMs or servers in the cluster or upstream service. This is typically done through health checks, which may involve pinging the servers, sending test requests, or monitoring performance metrics to ensure they are operational and can handle requests. The system (e.g., the load balancer) can implement one or more predefined algorithms in connection with determining how to distribute the incoming traffic among the available servers (e.g., upstream devices). Examples of common load balancing algorithms include:
Round Robin: Distributes requests sequentially across the servers.
Least Connections: Sends traffic to the server with the fewest active connections.
Least Response Time: Directs traffic to the server with the quickest response time.
IP Hash: Uses the client's IP address to determine which server will handle the request.
Weighted Distribution: Allocates traffic based on server capacities, with more powerful servers receiving more traffic.

The load balancer forwards the incoming requests to the selected server (e.g., the selected/assigned upstream device). In the case of a web application, for example, this would involve directing HTTP requests to different web servers. Various embodiments are configured to ensure that a client's requests (e.g., requests associated with a tenant or other group of sessions or devices associated with a virtual IP address) are consistently directed to the same server, such as by implementing session persistence or sticky sessions. The system can maintain session state information to ensure that traffic associated with a particular virtual IP address is consistently forwarded to a particular upstream device.

In some embodiments, if an upstream device (e.g., a server or virtual machine) becomes unresponsive or fails a health check, the load balancer automatically reroutes traffic to other healthy upstream device(s) (e.g., servers or virtual machines in the cluster), ensuring continued availability and minimal disruption to the service. The load balancer may correspondingly update a mappings of tuples to upstream devices to include the assignment of the tuple to the other upstream device(s) used as a failover.

In some embodiments, the system (e.g., the load balancer) is configured to facilitate the scaling of a particular application or service. The system can dynamically add or remove servers from the pool based on current load and performance metrics, facilitating both horizontal scaling (adding more servers) and vertical scaling (increasing the resources of existing servers).

At 625, the system forwards the packet to the upstream device. The system redirects network traffic to the upstream device to which the virtual IP address for the network traffic is assigned.

At 630, a determination is made as to whether process 600 is complete. In some embodiments, process 600 is determined to be complete in response to a determination that no further network traffic is to be communicated between the plurality of network nodes and the upstream device, a workload for the plurality of network nodes is complete, no further load balancing is to be performed, no further network traffic is to be routed, an administrator indicates that process 600 is to be paused or stopped, etc. In response to a determination that process 600 is complete, process 600 ends. In response to a determination that process 600 is not complete, process 600 returns to 605.

FIG. 7 is a flow diagram of a method for determining an upstream device to which to route or forward network traffic according to various embodiments. In some embodiments, process 700 is implemented at least in part by system 100 of FIG. 1, system 200 of FIG. 2, and/or system 300 of FIGS. 3A-3B.

In some implementations, process 700 is implemented by one or more servers, such as in connection with providing a service to a network (e.g., a security entity and/or a network endpoint such as a client device). In some implementations, process 700 may be implemented by a load balancing service (e.g., one or more servers that provide load balancing to a set of worker nodes or other upstream devices, etc.).

At 705, the system obtains an indication to determine an upstream device to which to forward the packet based at least in part on the tuple. At 710, the system obtains the tuple for the packet. At 715, the system queries a mappings of tuples to assigned upstream devices. At 725, the system determines whether the mappings comprises the tuple for the packet. In response to determining that the mappings of tuples to assigned upstream devices comprises the tuple for the packet at 720, process 700 proceeds to 725 at which the system determines the assigned upstream device based on the mappings. Conversely, in response to determining that the mappings of tuples to assigned upstream devices does not comprise the tuple for the packet at 720, process 700 proceeds to 730 at which the system selects an upstream device. At 735, the system assigns the tuple to the selected upstream device. At 740, the system stores the assignment in the mappings. In some embodiments, the system updates the mappings of tuples to assigned upstream devices to comprise a mapping of the tuple to the selected upstream device. At 745, the system provides an indication of the upstream device to which to forward the packet. The system can provide the indication of the upstream device the process or service that invoked process 700. At 750, a determination is made as to whether process 700 is complete. In some embodiments, process 700 is determined to be complete in response to a determination that no further network traffic is to be communicated between the plurality of network nodes and the upstream device, a workload for the plurality of network nodes is complete, no further load balancing is to be performed, no further network traffic is to be routed, no further tuples are to be assigned to upstream devices, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for managing an indication of a network node to which to provide response data according to various embodiments. In some embodiments, process 800 is implemented at least in part by system 100 of FIG. 1, system 200 of FIG. 2, and/or system 300 of FIGS. 3A-3B. Process 800 may be implemented by an upstream device such as a worker node, a virtual machine, etc. As an example, the upstream device is the upstream device to which a load balancer or other service forwards/redirects traffic such as based on a tuple associated with the traffic.

In some implementations, process 800 may be implemented by one or more servers, worker nodes, or virtual machines, such as in connection with providing a service to a network. For example, process 800 is implemented by one or more servers that provide a security platform (e.g., a cloud service) such as to provide traffic classifications, malicious file or traffic detections, etc.

At 805, the system obtains a packet for a workload. The workload may correspond to traffic for a particular tenant or group of devices or network nodes (e.g., a set of network nodes), etc.

At 810, the system obtains a virtual IP address for the packet. The system obtains the virtual IP address from the packet, such as by extracting the source IP address from the packet.

At 815, the system obtains a physical IP address for the packet. The system obtains the physical IP address from the packet, such as by extracting the physical IP address from metadata embedded in the packet (e.g., from the optional header or extension field in the packet).

At 820, the system stores a key-value pair based at least in part on the virtual IP address and the physical IP address. For example, if the system has not previously received traffic for the virtual IP address, the system creates and stores the key-value pair. As another example, if the system has previously received traffic for the virtual IP address, the system obtains a corresponding previously stored key-value pair (e.g., a mapping of virtual IP addresses to physical IP addresses) and determines whether the physical IP address communicated with the traffic associated with the virtual IP address is the same as the physical IP address mapped to the virtual IP address stored in the tuple. If the physical IP address associated with the traffic is different from the physical IP address mapped to the virtual IP address in the key-value pair (e.g., in the event of a switchover or failover), the system can update the key-value pair to map the virtual IP address to the new physical IP address.

At 825, a determination is made as to whether process 800 is complete. In some embodiments, process 800 is determined to be complete in response to a determination that no further packets are received (e.g., from downstream network devices, or network nodes, etc.), a workload for the plurality of network nodes is complete, no further key-value pairs are to be stored or updated, an administrator indicates that process 800 is to be paused or stopped, etc. In response to a determination that process 800 is complete, process 800 ends. In response to a determination that process 800 is not complete, process 800 returns to 805.

FIG. 9 is a flow diagram of a method for managing an indication of a network node to which to provide response data according to various embodiments. In some embodiments, process 900 is implemented at least in part by system 100 of FIG. 1, system 200 of FIG. 2, and/or system 300 of FIGS. 3A-3B. Process 900 may be implemented by an upstream device such as a worker node, a virtual machine, etc.

In some implementations, process 900 may be implemented by one or more servers, such as in connection with providing a service to a network. For example, process 900 is implemented by one or more servers that provide a security platform (e.g., a cloud service) such as to provide traffic classifications, malicious file or traffic detections, etc.

At 905, the system obtains a packet for a workload. At 910, the system obtains a virtual IP address for the packet. At 915, the system obtains a physical IP address for the packet. At 920, the system determines whether a key-value pair for the virtual IP address exists. For example, the system determines whether a key-value pair mapping a physical IP address to the particular obtained virtual IP address is stored (e.g., locally at the upstream device). In response to determining that a key-value pair for the virtual IP address does not exist (e.g., has not been pre-stored or pre-configured), process 900 proceeds to 925 at which the system creates a key-value pair to map the virtual IP address to the physical IP address. For example, the system maps the virtual IP address to the physical IP address (e.g., the physical IP address for a device from which the packet, or last packet, was received, or a physical address IP for a device to which a response is to be provided). At 930, the system stores the key-value pair. For example, the system stores a key-value locally at the upstream device that is to process the workflow. Conversely, in response to determining that a key-value pair for the virtual IP address exists (e.g., has been pre-stored or pre-configured), process 900 proceeds to 935 at which the system determines whether the physical IP address obtained from the packet (e.g., obtained at 915) is equal to the physical IP address in the key-value pair (e.g., the key-value pair for the virtual IP address associated with the workload). In response to determining that the physical IP address from the packet is not equal to the physical IP address in the key-value pair, process 900 proceeds to 940 at which the system update the key-value pair to map the virtual IP address to the physical IP address obtained from the packet. In response to determining that the physical IP address from the packet is equal to the physical IP address in the key-value pair, process 900 proceeds to 945 (e.g., the system does not update the key-value pair for the virtual IP address). At 945, a determination is made as to whether process 900 is complete. In some embodiments, process 900 is determined to be complete in response to a determination that no further packets are received (e.g., from downstream network devices, or network nodes, etc.), a workload for the plurality of network nodes is complete, no further key-value pairs are to be stored or updated, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for determining a downstream network node to which response data is to be provided according to various embodiments. In some embodiments, process 1000 is implemented at least in part by system 100 of FIG. 1, system 200 of FIG. 2, and/or system 300 of FIGS. 3A-3B. Process 1000 may be implemented by an upstream device such as a worker node, a virtual machine, etc.

In some implementations, process 1000 may be implemented by one or more servers, such as in connection with providing a service to a network. For example, process 1000 is implemented by one or more servers that provide a security platform (e.g., a cloud service) such as to provide traffic classifications, malicious file or traffic detections, etc.

At 1005, the system obtains an indication to send data to a downstream device. For example, the system obtains the indication to send data to a network node, such as a node from which a corresponding workload or request was received or a different node that has been set to operate in an active mode in response to a failover or switchover (e.g., from the node from which the corresponding workload or request was received).

At 1010, the system determines a virtual IP address associated with the data. In some embodiments, the system determines the virtual IP address based at least in part on determining a source IP address from which the request (e.g., the request to process the workload) was received.

At 1015, the system queries a key-value pair mappings based on the virtual IP address. The key-value pair mappings may be stored locally (e.g., at the upstream device or worker node processing a workload). As an example, the key-value pair mappings stores a mapping of virtual IP addresses to corresponding physical IP addresses which may serve as a location from which response data is to be sent (e.g., a location for the downstream device).

At 1020, the system obtains the physical IP address from the key-value pair mapping for the virtual IP address. For example, the system determines the physical IP address for which the key-value pair maps to the virtual IP address associated with the data to be sent to the downstream device (e.g., the virtual IP address associated with the workload).

At 1025, the system provides an indication that the destination IP address for the data to be sent to downstream device corresponds to the physical IP address. For example, the system determines to use the physical IP address mapped to the virtual IP address in the key-value pair as the destination IP address for the data to be sent (e.g., the response data for the workload).

At 1030, a determination is made as to whether process 1000 is complete. In some embodiments, process 1000 is determined to be complete in response to a determination that no further packets are to be sent (e.g., to downstream network devices, or network nodes, etc. in response to workloads, etc.), a workload for the plurality of network nodes is complete, no further response data (e.g., for a workload) is to be provided, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for processing a workload and providing response data according to various embodiments. In some embodiments, process 1100 is implemented at least in part by system 100 of FIG. 1, system 200 of FIG. 2, and/or system 300 of FIGS. 3A-3B. Process 1100 may be implemented by an upstream device such as a worker node, a virtual machine, etc.

In some implementations, process 1100 may be implemented by one or more servers, such as in connection with providing a service to a network. For example, process 1100 is implemented by one or more servers that provide a security platform (e.g., a cloud service) such as to provide traffic classifications, malicious file or traffic detections, etc.

At 1105, the system obtains a packet for a workload. At 1110, the system processes the workload. At 1115, the system determines to provide a response for the workload. At 1120, the system obtains a virtual IP address for the workload (e.g., the virtual IP address associated with the incoming traffic or otherwise associated with the tenant associated with the tenant). At 1125, the system obtains a physical address mapped to the virtual IP address in a key-value pair. At 1130, the system communicates the response for the workload based on the physical IP address. At 1135, a determination is made as to whether process 1100 is complete. In some embodiments, process 1100 is determined to be complete in response to a determination that no further packets are to be sent (e.g., to downstream network devices, or network nodes, etc. in response to workloads, etc.), a workload for the plurality of network nodes is complete, no further response data (e.g., for a workload) is to be provided, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for handling a switchover or failover according to various embodiments. In some embodiments, process 1200 is implemented at least in part by system 100 of FIG. 1, system 200 of FIG. 2, and/or system 300 of FIGS. 3A-3B. Process 1200 may be implemented by an upstream device such as a worker node, a virtual machine, etc.

In some implementations, process 1200 may be implemented by one or more servers, such as in connection with providing a service to a network. For example, process 1200 is implemented by one or more servers that provide a security platform (e.g., a cloud service) such as to provide traffic classifications, malicious file or traffic detections, etc.

At 1205, the system obtains an indication to send traffic to an upstream device via a network node operating in an active mode.

At 1210, the system obtains a virtual IP address associated with the network node operating in the active mode.

At 1215, the system communicates traffic to the upstream device with the physical IP address of the network node comprised in the traffic metadata.

At 1220, the system determines whether a switchover is to be performed. For example, the system determines whether the network node operating in the active mode has failed, or is predicted to fail (e.g., within a predefined period of time). In response to determining that the network node operating in the active mode has failed, the system determines to perform a switchover (e.g., a failover) to another network node, such as a network node operating in a standby mode. The system may determine to switchover to use another network node in the active mode for various other reasons.

In some embodiments, the system determines not to perform a switchover in response to determining that the network node operating in the active mode has not failed.

In response to determining that a switchover is not to be performed at 1220, process 1200 proceeds to 1225 at which the system determines whether to continue communicating traffic. As an example, the system determines whether additional requests for a workload are to be processed, or a session at the network node is still operating. In response to determining to continue communicating traffic at 1225, process 1200 returns to 1215 and process 1200 iterates over 1215-1225 until no further traffic is to be communicated, such as the workload being completed or the session being terminated. Conversely, in response to determining that the communication of traffic is not to continue, process 1200 proceeds to 1240.

In response to determining that a switchover is to be performed at 1220, process 1200 proceeds to 1230 at which the system selects a network node operating in standby mode to be set to operate in an active mode. For example, the system determines to proceed with using a different network node to communicate traffic to the upstream device for a session or workload, etc. At 1225, the system obtains the physical IP address for the newly selected network node to operate in the active mode. For example, for future packets (e.g., until another switchover or failover, etc.) to be communicated to the upstream device (e.g., for the particular workload, session, etc.) the system associates the traffic being communicated to the upstream device (e.g., for the particular session or workload) with the physical IP address for the newly selected network node to operate in the active mode.

At 1240, a determination is made as to whether process 1200 is complete. In some embodiments, process 1200 is determined to be complete in response to a determination that no further traffic is to be communicated (e.g., to downstream network devices, or network nodes, etc. in response to workloads, etc.), a workload for the plurality of network nodes is complete, no further response data (e.g., for a workload) is to be provided, an administrator indicates that process 1200 is to be paused or stopped, etc. In response to a determination that process 1200 is complete, process 1200 ends. In response to a determination that process 1200 is not complete, process 1200 returns to 1205.

Although the examples provided herein are primarily described in the context of a failover, various embodiments can similarly handle switchovers more generally.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system for performing failovers of traffic carrying devices, comprising:
one or more processors configured to:
generate a virtual routing IP address that is common to a plurality of network nodes; and
send to an upstream device a physical IP address for a particular network node of the plurality of network nodes, wherein the physical IP address is sent as metadata in a packet to the upstream device; and
a memory coupled to the one or more processors and configured to provide the one or more processors with instructions.

2. The system of claim 1, wherein at least one of the plurality of network nodes operates in an active mode, and at least one other of the plurality of network nodes operates in a standby mode.

3. The system of claim 1, wherein the plurality of network nodes comprises one or more virtual firewalls or one or more software defined networking (SDN) entities.

4. The system of claim 1, wherein responses that are sent back from the upstream device use the physical IP address comprised in the metadata as a destination IP address for routing.

5. The system of claim 1, wherein:
the plurality of network nodes comprises a first network node operating in an active mode; and
traffic from the first network node is obtained by a load balancer that directs the traffic to the upstream device.

6. The system of claim 5, wherein the load balancer routes the traffic to the upstream device based at least in part on the virtual routing IP address common to the plurality of network nodes.

7. The system of claim 5, wherein:
the load balancer routes traffic among a plurality of upstream devices based at least in part on a 5-tuple comprising: (a) a source IP address, (b) a destination IP address, (c) destination port, (d) a source port, and (e) a protocol; and
the source IP address is set to be the virtual IP address associated with the traffic.

8. The system of claim 7, wherein traffic from different network nodes of the plurality of network nodes that are each associated with the same virtual IP address is routed to a same upstream device.

9. The system of claim 1, wherein the upstream device is a virtual machine.

10. The system of claim 1, wherein the upstream device is a router.

11. The system of claim 1, wherein the physical IP address comprised in the metadata ensures that traffic is routed back to a corresponding source network node comprised in the plurality of network nodes.

12. The system of claim 1, wherein the upstream device stores a key-value mapping that is used to determine a particular network node to which a response is to be sent back.

13. The system of claim 1, wherein the upstream device stores a key-value mapping comprising a mapping of the virtual IP address to the physical IP address.

14. The system of claim 13, wherein the key-value mapping comprises a single physical IP address mapped to the virtual IP address.

15. The system of claim 13, wherein:
the physical IP address comprised in the metadata corresponds to a first network node operating in an active mode from which traffic to the upstream device is communicated;
the upstream device stores a key-value mapping that maps the virtual IP address to the physical IP address for first network node; and
the key-value mapping is updated to map the virtual IP address to a different physical IP address associated with a second network node when a failover from the first network node to the second network node is performed.

16. The system of claim 15, wherein in response to the updating of the key-value mapping, the upstream device sends a response to the second network node.

17. The system of claim 13, wherein:
the upstream device stores a key-value mapping that maps the virtual IP address to the physical IP address for an active network node; and
the key-value mapping is updated to map the virtual IP address to a different physical IP address associated with a standby network node if the active network node fails.

18. The system of claim 1, wherein:
the upstream device stores a key-value mapping that maps the virtual IP address to the physical IP address for an active network node; and
the upstream device implements a heartbeat mechanism to periodically verify that the active network node is operating.

19. The system of claim 18, wherein the upstream device updates the key-value mapping to map the virtual IP address to a different physical address for a standby network node in response to determining, based at least in part on the heartbeat mechanism, that the active network node is not operating.

20. The system of claim 1, wherein the packet communicated to the upstream device is configured based on a TCP protocol.

21. The system of claim 1, wherein the metadata comprising the physical IP address is inserted into an optional header of the packet.

22. A method for performing failovers of traffic carrying devices, comprising:
generating, by one or more processors a virtual routing IP address that is common to a plurality of network nodes; and
sending to an upstream device a physical IP address for a particular network node of the plurality of network nodes, wherein the physical IP address is sent as metadata in a packet to the upstream device.

23. A computer program product embodied in a non-transitory computer readable medium and comprising computer instructions for:
generating, by one or more processors a virtual routing IP address that is common to a plurality of network nodes; and
sending to an upstream device a physical IP address for a particular network node of the plurality of network nodes, wherein the physical IP address is sent as metadata in a packet to the upstream device.
